(19) United States
(12) Patent Application Publication
(10) Pub. No.: US 2013/0088602 A1
(43) Pub. Date: Apr. 11, 2013

(54) INFRARED LOCATOR CAMERA WITH THERMAL INFORMATION DISPLAY

(71) Applicant: Howard Unger, Henderson, NV (US)

(72) Inventor: Howard Unger, Henderson, NV (US)

(21) Appl. No.: 13/269,373

(22) Filed: Oct. 7, 2011

(51) Int. Cl. H04N 5/33

(52) U.S. Cl. 348/164; 348/E05.09

(57) ABSTRACT

An infrared locator provides a camera image of a scene while collecting thermal information via a thermal sensor. A direction indicator may be provided to indicate the direction of a heat source allowing the user to easily find the heat source. Alternatively or in addition a thermal indicator, such as a graph showing thermal levels, may be provided to allow the user to find a heat source. The infrared locator may display these indicators without obscuring any portion of the camera image. In addition, the infrared locator may have a memory device for recording images and thermal information.

### BACKGROUND OF THE INVENTION

1. Field of the Invention

The invention relates to infrared imaging devices and in particular to an infrared locator with thermal information display.

2. Related Art

Infrared light technology has a number of useful applications. As is known, infrared light is used in surveillance and tracking systems, especially in situations where ambient light is at a low level to allow such systems to effectively see in the dark. Infrared light can also be used to measure temperature for monitoring or inspection purposes. For example, temperature variations, high or low spots, or the like may be detected by measuring infrared light.

Various imaging devices have been devised to harness the properties of infrared light. For example, traditional infrared imaging devices provide an overlay of thermal information over an image or view of a scene. Portions of the image or view are thus replaced or covered by thermal information, such as by dots or other regions of distinct color. A user may then identify a thermal source by looking at the various colored regions of the image or view of the scene.

In order to accomplish such overlay, the thermal information must be aligned relative to the image or view of a scene. Then, various portions of the image or view can be replaced or covered with colored regions representing various thermal readings. Traditional devices which provide such functionality are therefore relatively complex and thus have increased expense. As a result, though useful, the use of such imagers has been substantially limited to military, police, corporate, and professional uses.

From the discussion that follows, it will become apparent that the present invention addresses the deficiencies associated with the prior art while providing numerous additional advantages and benefits not contemplated or possible with prior art constructions.

### SUMMARY OF THE INVENTION

An infrared locator is disclosed herein. In general, infrared locator allows a user to easily locate a thermal or heat source within a scene. The infrared locator may provide a visual image of the scene so that the user can readily identify the physical object or area corresponding to the thermal source. A distance indicator and/or thermal indicator may be used to allow the user to pinpoint the thermal source within the image of the scene. The user may be alerted when the thermal source is pinpointed, such as when the thermal source is located in a central portion of the image of the scene. These indicators may be configured such that they do not obstruct the user's view of the scene.

The infrared locator may have various configurations. For example, in one embodiment, the infrared locator may comprise a camera for capturing one or more images, and a thermal detector aligned with the camera comprising a plurality of thermal sensors for capturing thermal information. The thermal sensors may be arranged in various arrangements. For example, the thermal sensors may be in a grid pattern. The thermal detector may be aligned with the camera such that a center or centrally located thermal sensor is focused on the same area as the camera.

A display having an image area configured to display the images, and a direction indicator configured to indicate a location of a thermal source based on the thermal information will typically also be included. The direction indicator may present one or more arrows to indicate the location of the thermal source. This allows a user to pinpoint or locate the thermal source, such as by centering an image of the thermal source on the display. It is noted that a thermal indicator configured to display the thermal information may also or alternatively be provided outside the image area.

The direction indicator may have various configurations. For example, the direction indicator may comprise a frame surrounding the image area, the direction indicator having a plurality of sections that alter their appearance to indicate the location of the thermal source. The direction indicator may be outside the image area so as to no obscure or block any portion of the image area. The direction indicator may have a plurality of segments, with each of the segments associated with one of the thermal sensors. In this manner, one of the segments may be activated when its associated thermal sensor detects the highest thermal radiation intensity of all the thermal sensors. This indicates the direction of the thermal source to the user.

In another exemplary embodiment, an infrared locator may comprise a camera configured to capture one or more images of a scene having a plurality of areas, and a plurality of thermal sensors arranged in a predefined arrangement such that each of the thermal sensors receives thermal radiation from one of the areas of the scene. The thermal sensors will typically be configured to generate temperature information from the thermal radiation. One or more memory devices configured to record one or more of the images of the scene may be provided as well.

A display having an image area configured to display one or more images captured by the camera may also be provided along with a direction indicator surrounding the image area. The direction indicator may have a plurality of segments configured to change their appearance to indicate the location of a thermal source. Each of the segments may be associated with one of the areas of the scene. This allows the direction indicator to specify a direction of a thermal source by activating (i.e., changing the appearance of) a segment associated with an area of the scene containing the thermal source.

It is noted that the direction indicator may comprise a plurality of lights arranged around the display. In such case, the segments may be configured to change their appearance by illuminating one or more of the lights.

A processor may be used to change the appearance of one of the segments based on a comparison between temperature information from an area associated with the one of the segments and temperature information from the other areas of the scene. For instance, the processor may change the appearance of the one of the segments when the thermal information from the area associated with the one of the segments is higher than the temperature information from the other areas of the scene. In addition, the processor may be configured to change the appearance of all of the segments when highest temperature information is being detected by a centrally located one of the thermal sensors.

It is noted that the infrared locator may have a plurality of operating modes. For instance, there may be one operating mode where the display is configured to display only temperature information. In another operating mode, the display may be configured to replace the direction indicator with a graph showing temperature information from one or more of the thermal sensors in at least one of the operating modes, the graph being located outside the image area.

Various methods of locating heat sources with a infrared locator are disclosed herein as well. For example, in one embodiment a method of locating a source of thermal radiation may comprise providing an infrared locator comprising a plurality of thermal sensors and a camera, displaying an image of a scene captured by the camera on a display of the infrared locator, and receiving thermal radiation from various areas of the scene at each of the thermal sensors. Temperature information indicating the temperature of the various areas of the scene may be generated from the thermal radiation.

The method may include providing one or more operating modes at the infrared locator. For example, a first operating mode may be provided where a portion of a direction indicator indicates the location of the source of thermal radiation by changing its appearance. The portion of the direction indicator may be selected based on the temperature information.

Continuing the example, a second operating mode may be provided where a graph showing temperature information is displayed next to the image of the scene on the display of the infrared locator. It is noted that the graph and the direction indicator may not (but could if desired) be displayed at the same time when switching between operating modes. Also for example, a third operating mode could be provided where only the temperature information is displayed on the display of the infrared locator.

The user may be assisted in finding a thermal source in various ways. For example, the entire direction indicator may change its appearance when a centrally located one of the thermal sensors detects a higher temperature than the other of the thermal sensors (meaning that the thermal source has been pinpointed at a central thermal sensor). Alternatively or in addition, an additional indicator may be activated when a centrally located one of the thermal sensors detects a higher temperature than the other of the thermal sensors.

The image of the scene may be recorded on a memory device of the infrared locator when desired. In addition, the image of the scene may be automatically recorded on a memory device of the infrared locator when a centrally located one of the thermal sensors detects a higher temperature than the other of the thermal sensors.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A is a back perspective view of an exemplary infrared locator;

FIG. 1B is a front perspective view of an exemplary infrared locator;

FIG. 2 is a block diagram of an exemplary infrared locator;

FIG. 3A illustrates a display and thermal sensor of an exemplary infrared locator in operation;

FIG. 3B illustrates a display and thermal sensor of an exemplary infrared locator in operation;

FIG. 3C illustrates a display and thermal sensor of an exemplary infrared locator in operation;

FIG. 4 is a flow diagram illustrating operation of an exemplary infrared locator;

FIG. 5 is a flow diagram illustrating operating modes of an exemplary infrared locator; and

FIG. 6 illustrates a display of an exemplary infrared locator in operation.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the infrared locator herein captures and displays thermal information associated with an image of a scene without obscuring a user's ability to see various areas or particular objects in the scene. In this manner, a user may easily locate a particular object or area based on thermal information. In one or more embodiments, the infrared locator may also assist the user in finding an area or object having a particular thermal signature, such as by directing the user to such area or object. In addition, the infrared locator provides these capabilities at low cost thus allowing wide spread use of thermal imaging technology.

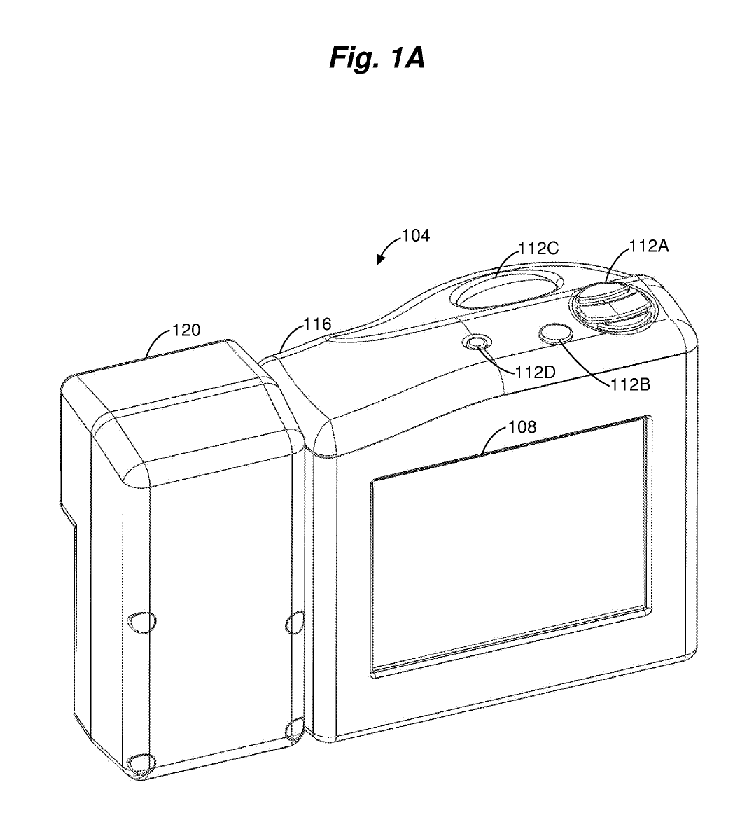

The infrared locator will now be described with regard to FIGS. 1A-1B. FIG. 1A provides a back isometric view of an exemplary infrared locator 104, while FIG. 1B provides a front isometric view of the same. As can be seen, the infrared locator 104 may comprise an enclosure 116 configured to support and/or secure one or more of its various components. For example, as can be seen the enclosure 116 may support a display 108, one or more inputs 112, as well as various internal components of the infrared locator, as will be described further below.

In one or more embodiments, the enclosure 116 may have one or more sections that may be movable or rotatable relative to one another. For instance, as shown the enclosure 116 comprises a swiveling portion 120. Like the rest of the enclosure 116, the swiveling portion 120 may support various infrared locator components. For example, the swiveling portion 120 may hold various imaging or sensing components, such the camera 128 and thermal detector 132 shown in FIG. 1B.

A camera 128 may be configured generally to capture image in the visual light spectrum, while a thermal detector 132 may be configured to measure infrared wavelengths. It is contemplated that the camera 128 could have a range beyond visual wavelengths such as to allow low light imaging. Likewise the thermal detector 132 may have an extended wavelength range as well. In some embodiments, the wavelengths detectable by the camera 128 and thermal detector 132 may partially overlap.

In one or more embodiments, the camera 128 may comprise one or more lenses and an image sensor, such as a CCD or the like. The lens or lenses may be variable to allow the camera 128 to zoom in or out on objects at various distances. In other embodiments, the lens or lenses may be fixed. Fixed lenses may be configured to have a larger aperture to increase low light imaging capabilities.

A thermal detector 132 may be configured to capture thermal information, such as temperature information, at a particular area or point. In general, this area will be the area at which the thermal detector 132 is pointed. It is noted that a thermal detector 132 or multiple thermal detectors may be used to capture thermal information at multiple areas at the same time such as to generate thermal information for a large area.

A thermal detector 132 may comprise one or more thermal sensors, such as passive infrared (PIR) sensors or other infrared/temperature sensors in one or more embodiments. In general, the PIR sensors or other thermal sensors convert infrared radiation into one or more signals that may be interpreted or processed by the infrared locator 104. For instance, a thermal sensor may receive infrared radiation and convert it into electrical signals which may then be interpreted to obtain a temperature value. In this manner, temperature readings from various areas of a scene or environment can be obtained by the thermal detector 132.

In embodiments with multiple thermal sensors, it is contemplated that the sensors may be arranged in a grid pattern, as will be described further below. In this manner, the infrared locator 104 can determine the location of a thermal source based on the thermal levels detected by individual thermal sensors. For example, the thermal sensor or sensors detecting the highest thermal intensity may indicate the source of the thermal radiation (i.e., the thermal source), especially if nearby thermal sensors are detecting a gradually decreasing level of thermal radiation. The ability to determine a location of a thermal source is advantageous in that it allows the infrared locator 104 to present an indicator of the location of the thermal source relative to the current position of the infrared locator 104, as will also be described further below.

It is noted that multiple cameras 128, multiple thermal detectors 132, or both may be provided in some embodiments. An additional camera 128 or thermal detector 132 may be configured to capture different wavelengths. In this manner, a particular camera 128 and thermal detector 132 combination may be used depending on the surrounding environment. For instance, a first combination may be used depending on the available light, temperature, humidity, or other characteristic of the surrounding environment, while a second combination may be used when those characteristics are outside or beyond a particular range or threshold. It is contemplated that multiple thermal detectors 132 may also be used to increase the accuracy of the thermal locator 104, such as by providing two independent sources of thermal information.

The swiveling portion 120 may also support one or more illuminating components, such as one or more visible light or infrared flash/illumination components. This is beneficial in that these components may be moved relative to the display 108 such as to target various areas or objects. To illustrate, as shown in FIG. 1B, the swiveling portion 120 may support one or more infrared flash/illumination components 124, cameras 128, and/or a thermal detectors 132. Since these components are attached to the same support, they may be moved and thus targeted at an object or area in unison. It is noted that the enclosure 116 need not have movable or swiveling portions in some embodiments. In such case, the imaging and/or illuminating components may simply be mounted to an area of the enclosure 116.

As can be seen, the enclosure 116 may have a rectangular shape with the display 108 and imaging/illuminating components on opposite sides. In FIGS. 1A-1B for example, the display 108 is at the back of the enclosure 116 while the imaging/illuminating components are at the front of the enclosure. In this manner, the display 108 may face the user while the imaging/illuminating components point away from the user to allow the surrounding scene to be captured. The captured information (e.g., images, thermal information, etc. . . . ) along with information that assists the user in finding a thermal source may be presented to the user via the display 108 and/or other output devices as will be described further below.

The display 108 may have various configurations. For example, the display 108 may be an LCD screen, OLED screen or other display technology. As stated above in some embodiments, the display 108 may include on or more inputs 112 such as a touch panel. The display 108 may provide an image area for displaying captured images from the infrared locator's camera 128. The image area may be a portion of the display 108 so as to save some area for other elements, such as direction indicators and/or thermal indicators (which will be described below). In one or more embodiments, the image area may be exclusively for displaying images from the camera 128. In this manner, the images are not obstructed or blocked in anyway, allowing the user to easily see a thermal source as well as its surroundings.

One or more user inputs 112, such as buttons, switches, toggles, touch screens, and the like may be at the top of the enclosure 116 such as shown. Though illustrated in a particular arrangement, it is contemplated that these components may be located at various locations on the enclosure 116. For instance, one or more inputs 112 may be at the back or front or the bottom of the enclosure.

The inputs 112 may have various functions. For example, one or more inputs, such as one or more control buttons 112A, may be used to control image capture, such as to zoom, focus, and record images and video. The control buttons 112A may be used to change camera settings such as by allowing a user to navigate one or more user interface menus and input corresponding information.

The infrared locator 104 may also include inputs 112 to control its mode and/or its imaging functions. For example, the infrared locator 104 may also have a mode input, such as a mode button 112B, to change or toggle the infrared locator's imaging mode. As will be described further below, this may change what is displayed on the display 108 and/or what information is captured by the infrared locator's imaging components. In addition, the imaging mode may define what illumination, if any, is active.

It is noted that one or more inputs 112 may be provided for manual control of various imaging functions. For example, in one or more embodiments, a manual illumination button 112C or other input may be used to control the activation and/or deactivation of an infrared or other illuminator 124. In one or more embodiments, this may be used to override automatic settings provided by an imaging mode. For instance, the illumination button 112C may be used to turn on or off illumination during video recording. Alternatively or in addition, the illumination button 112C could be used to turn on or off an infrared or other flash, such as during still image capture.

The enclosure 116 may also be configured to allow a user to more easily hold the infrared locator 104. For example, the enclosure 116 may have a size and/or shape which makes the infrared locator 104 ergonomic. As shown in FIG. 1B for example, the enclosure 116 may include one or more curves, angles or other shapes to allow a user to more easily grasp the infrared locator 104 when capturing images and thermal information. Various surface areas of the enclosure 116 or the entire enclosure may have a textured surface or the like, such as to increase grip at such areas.

It is contemplated that the enclosure 116 may be ruggedized such as to withstand impacts that may be encountered while the infrared locator 104 is in use. For example, the enclosure 116 may be formed from a resilient material such as plastic that can withstand being dropped, bumped, or other physical impacts. The enclosure 116 may also or alternatively be sealed such as to protect the components of the infrared locator 104 from moisture, particulates, and other contaminants. This allows the infrared locator 104 to be used in various environments. The enclosure 116 may be moisture resistant or watertight so as to allow the infrared locator 104 to be used in high humidity, underwater, or in other wet environments.

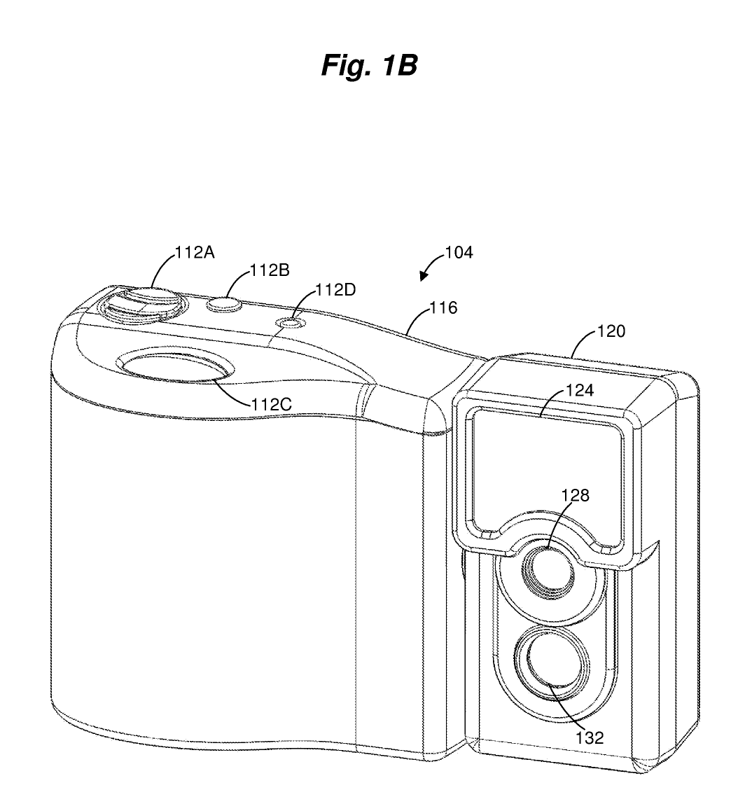

FIG. 2 is a block diagram illustrating the components of an exemplary infrared locator 104 and exemplary interconnections. As can be seen, the infrared locator 104 may have (among other things) a processor 204, memory device 208, and power source 216.

In one or more embodiments, the processor 204 may be one or more integrated circuits or the like configured to execute one or more instructions to provide the functionality disclosed herein. The processor 204 may be hardwired to provide this functionality or may execute machine readable code, which it may retrieve from a memory device 208. It is noted that a memory device 208 may be integrated into the processor 204 in some embodiments. In addition, it is noted that multiple processors 204 may be provided. In such embodiments, the processors 204 may function as backups to one another and/or be configured to perform particular processing tasks. For instance, a first processor may be configured to analyze thermal information while another processor may be used for image processing/compression.

As can be seen in FIG. 2, the processor 204 may send and receive data and/or commands to and from the other components of the infrared locator 104 to capture video or still images and/or locate thermal sources, as will be described further below.

For example, the processor 204 may receive user input from one or more inputs 112, such as the control buttons 112A, mode button 112B, illumination button 112C, and on/off button 112C described above. In addition, input in the form of captured images and thermal information may be received by the processor 204 from the camera 128 and thermal detector 132 of the infrared locator 104. Based on this input, the processor 204 may operate various components of the infrared locator 104. For example, the processor 204 may activate or deactivate an illuminator 124 based on ambient light levels, thermal information, or both.

The processor 204 may also present capture images to a user via the display 108. In one or more embodiments, the processor 204 may analyze the input it receives to provide additional information to a user. For example, the processor 204 may operate a direction indicator 220 to denote the location of a thermal source relative to the current orientation of the infrared locator 104. Alternatively or in addition, the thermal information may be compiled into a visual representation, such as graph, to present heat levels as the thermal locator 104 is moved. The thermal information may be presented to a user via a thermal indicator 224.

As shown in FIG. 2, the direction indicator 220 and thermal indicator 224 may be part of the display 108. For instance, as will be described below, the direction indicator 220 and thermal indicator may be presented on various portions of the display 108. Typically and advantageously, the direction indicator 220 and thermal indicator 224 will be separate from an image of the scene captured by the infrared locator's camera 128 so as to no obscure a user's view of the scene.

It is contemplated that the direction indicator 220 and/or thermal indicator 224 may be presented on different display components. For example, multiple displays 108 may be provided. One or more of these additional displays 108 may present the direction indicator 220 and/or thermal indicator 224. Alternatively, the direction indicator 220 and/or thermal indicator 224 may comprise a set of lights or other indicators. For example, the direction indicator 220 may comprise LED or other lights which illuminate to indicate which direction a heat source is located. Likewise, the thermal indicator 224 may comprise LED or other lights which illuminate to indicate a thermal level or temperature reading.

In addition to machine readable code, a memory device 208 may store captured video, still images, and audio (if the infrared locator has an audio input). Thermal information captured by one or more thermal detectors 132 may also be stored on a memory device. In one or more embodiments, thermal information may be stored along with the captured images of a scene for example. In addition, a memory device 208 may store user preferences or presets through which a user may customize the operation of the infrared locator 104. These user preferences may be received through one or more inputs 112.

A memory device 208 may utilize various data storage techniques. For example, a memory device 208 may be magnetic, flash, optical, RAM, or ROM storage. In addition, it is contemplated that a memory device 208 may have removable media such as a removable disk, drive, or other medium. A memory device 208 may be user to store temporary data as well, such as when used as RAM. For instance, a memory device 208 may be used as cache memory and/or a medium to store or buffer captured images or audio before it is written to a memory device configured for nonvolatile storage.

Multiple memory devices 208 may be used to provide data storage of various types for the infrared locator 104. For instance a first memory device 208 may be used to store captured information, such as images and thermal information. One or more other memory devices 208 may be used as cache memory, RAM, ROM, machine readable code storage, or the like.

The infrared locator 104 may be powered by an internal power source 216, such as a battery. This allows the infrared locator 104 to be portable. It is contemplated that the power source 216 may also generate power in some embodiments. For instance, the power source 216 may be a solar panel or the like. In addition, the power source 216 may be or include external power such as electrical power from the grid. In one or more embodiments, the power source 216 may be removed and replaced when depleted. Alternatively or in addition, the power source 216 may be rechargeable.

The infrared locator 104 may also include one or more communication interfaces 212, to allow communication of data with external devices. For example, captured images and thermal information may be shared with a computer or other external device through a communication interface 212. This data may be shared as it is captured (i.e., live) or may be shared from a memory device 208 having recorded previously captured images and thermal information. A communication interface 212 may be wired or wireless and support various communication protocols for compatibility with other devices.

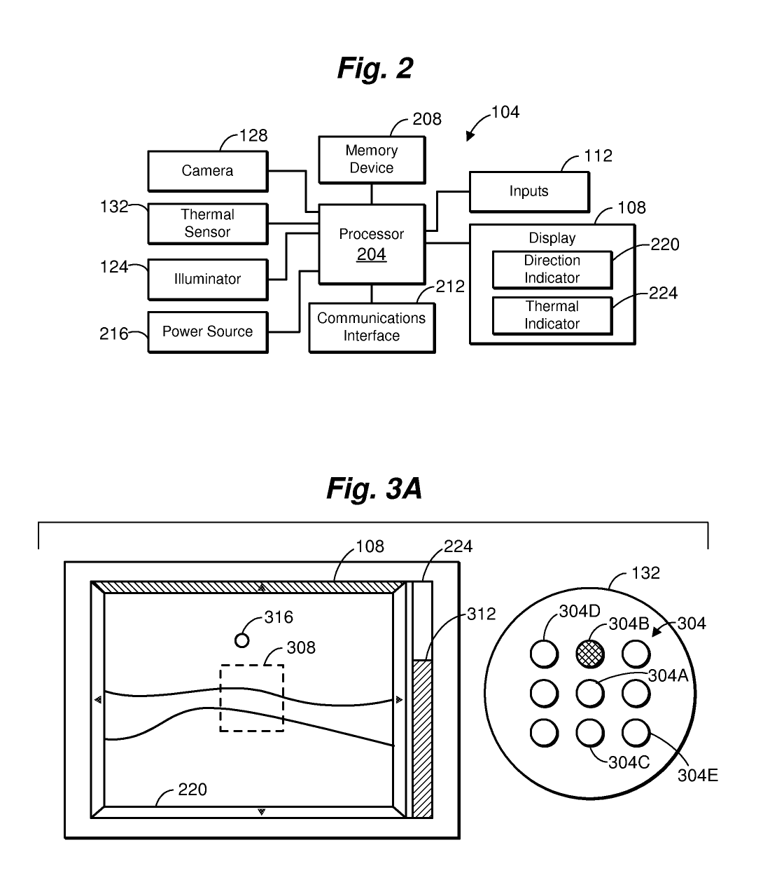

Operation of the infrared locator 104 will now be described with regard to FIGS. 3A-3C, which illustrate the presentation of various information to a user via a display 108 along with corresponding thermal detector 132 activity. It is noted that the display 108 and thermal detector 132 are illustrated next to one another for the purpose of explaining the operation of the infrared locator. As can be seen, FIGS. 3A-3C illustrate an exemplary display 108 and thermal detector 132 comprising a plurality of thermal sensors 304 in a grid arrangement. Though illustrated as a 3×3 grid, it is noted that the individual sensors 304 may be positioned in other arrangements. For instance, larger grids and/or non-square grids may be used. In addition, it is contemplated that the individual sensors 304 need not be placed in a grid pattern. For instance the sensors 304 may be arranged in concentric squares, rectangles, circles or other shapes.

As will now be described, the position of the sensors 304 allows the infrared locator 104 to pinpoint the location of a thermal source. The infrared locator 104 can then direct the user to the source so that the user can identify the heat source. In one or more embodiments, the camera 128 of the infrared locator 104 and the thermal detector 132 may be aligned such that the image captured by the camera contains the thermal source. For instance, the camera 128 and thermal detector 132 can be aligned such that a center or centrally located thermal sensor 304A and the center of the camera's view 308 are aimed at the same area. In this manner, the centrally located thermal sensor 304 detects thermal radiation at an area corresponding to the center of the camera's view of a scene. The surrounding thermal sensors 304 can then detect thermal radiation corresponding to areas adjacent the center of the camera's view, such as to the sides, top and bottom, or diagonally from the center of the view. Though illustrated as broken lines on the display 108, it is contemplated that the center of the camera's view 308 need not be identified to the user in this manner, such as to prevent obscuring the user's view of the image.

FIGS. 3A-3C also illustrate an exemplary thermal indicator 224 in the form of a temperature graph. As shown, the thermal indicator 224 displays a temperature level 312 which increases for higher temperatures and decreases for lower temperatures. It is contemplated that the color of the thermal indicator 224 may change for different temperatures. In embodiments utilizing lights, the thermal indicator 224 may illuminate additional lights to indicate a higher detected temperature. It is contemplated that the thermal indicator 224 may only display thermal information from one or some of the thermal sensors 304. In this manner, the thermal indicator 224 can provide temperature information for a portion of the scene the user is viewing on the display 108. In this manner, the user may see only the temperature readings from the center of the camera's view 304 for example. Alternatively or in addition, the thermal indicator 224 may present an aggregated display of thermal information such as by averaging or otherwise combining temperature readings from multiple thermal sensors 304.

As can be seen, though displayed via the display 108, the thermal indicator 224 is separate from the image captured by the infrared locator's camera 128. As shown, the thermal indicator is at the side of the captured image for example. In this manner, the thermal indicator 224 does not obscure the image.

A direction indicator 220 may also be separate from the captured image. As can be seen for instance, the direction indicator 220 forms a frame around the image without overlapping or obscuring the image. This preserves the image as it has been captured by the infrared locator's camera 128.

The direction indicator 220 may be configured to identify a plurality of directions. As shown in FIGS. 3A-3C for example, the direction indicator 220 has separate portions or sections, each containing an up, down, left, and right indicator. It is contemplated that a combination of indicators could be used to indicate additional directions. For instance, illuminating or otherwise changing the appearance of the top and right indicator may be used to indicate a heat source that is upward and rightward (i.e., diagonal) from the infrared locator's current position. Other directions may be indicated by illuminating or changing the appearance of the appropriate portion or portions of the direction indicator 220.

In some embodiments, one or more diagonal indicators may be provided. In such embodiments, two or more indicators may be activated, such as to indicate that a thermal source is at an angle between the two indicators. When the thermal source is centered in the camera's view 308, all portions of a direction indicator 220 or a separate indicator may be activated to notify the user that the thermal source is positioned in the center of the camera's view 308.

Operation of the infrared locator 104 will now be described with regard to FIGS. 3A-3C. FIG. 3A illustrates the infrared locator 104 displaying a scene captured by its camera. A thermal source 316 is illustrated within the scene, but this thermal source may not be as readily visible in real world operation. For example, in low light conditions or in situations where the thermal source 316 is surrounded by other objects the thermal source may not be readily visible or identifiable.

As shown in FIG. 3A, the direction indicator 220 has its top arrow illuminated to indicate to the user that the infrared locator 104 should be moved upward to center the thermal source 316 in the center of the camera's view 308. It is noted that the direction indicator 220 may be configured to assist a user in positioning a thermal source 316 in other locations of the camera's view besides the center.

As is also shown in FIG. 3A, the direction indicator's top arrow may be illuminated because the center top thermal sensor 304B is receiving higher intensity or highest intensity thermal radiation, thus indicating a thermal source 316 is upward from the thermal locators current position.

In FIG. 3B, the direction indicator 220 has its down arrow activated, indicating that the thermal source 316 is below the center of the camera's view 308. As such the user is notified that he or she should move or rotate the infrared locator 104 (or at least the imaging/sensing components of the infrared locator) downward to center the thermal source 316. Similar to above, the center bottom thermal sensor 304C is receiving higher or highest intensity thermal radiation in this case.

FIGS. 3A-3B also show the presentation of temperature information by the thermal indicator 224. In these illustrations, the thermal indicator 224 displays temperature information from a central thermal sensor 304A. Since, in these exemplary illustrations, the thermal source 316 is about the same distance from the center of the camera's view 308, the thermal indicator 224 may display similar temperature readings as shown in FIGS. 3A-3B. When the thermal source 316 is centered in the camera's view 308 and thus on the central thermal sensor 304A, the temperature reading would increase since the user is now pointing the central sensor 304A directly at the thermal source 316. This increase is shown by the thermal indicator 224 as illustrated in FIG. 3C.

As disclosed above, the thermal indicator 224 may be used to display thermal information from a plurality of thermal sensors 304. In such case, the user may use the thermal indicator 224 to monitor temperature readings generally. In the case where the thermal indicator 224 displays thermal information from a select one or more thermal sensors, it can be seen that the thermal indicator 224 may be used to locate the thermal source 316 such as by moving the infrared locator 104 until a maximum or high temperature reading is found.

It is contemplated that the direction indicator 220 may also indicate that the thermal source 316 has been located at the center of the camera's view 308. For instance, as shown in FIG. 3C all the arrows or indicators of the direction indicator 220 may be illuminated. In this case, the illumination or activation of the direction indicator 220 in this manner indicates that the thermal source 316 is in the center of the camera's view 308. Also, as can be seen, when the thermal source 316 is in the center of the camera's view 308, the center thermal sensor 304A may be receiving higher or highest intensity thermal radiation.

Continuing the above examples, it can be seen that the direction indicator 220 may be activated in different ways based on the levels of thermal radiation received at the individual thermal sensors 304. For instance, if the upper left thermal sensor 304D receives higher thermal radiation, both the up and left arrow (or a diagonal arrow) of the direction indicator 220 may be illuminated or activated to indicate the location of the thermal source 316. Alternatively, if the lower right thermal sensor 304E receives higher thermal radiation, both the down and right arrow (or a corresponding diagonal arrow) may be activated to indicate the location of the thermal source 316. This may occur for each of the thermal sensors 304 at their various locations within the thermal detector 132.

In some embodiments, the intensity of the illumination of the direction indicator's arrows may increase or decrease depending on the distance of the thermal source 316 from the center of the camera's view 308. For example, the intensity may be lower when the thermal source 316 is further from center than when the thermal source is closer to center. This provides an indicator to the user so that the user is aware of how much to move the infrared locator 104 to find and/or center the thermal source 316.

It is contemplated that the direction indicator 220 need not have arrows in all embodiments. For example, the direction indicator 220 may be a frame having segments which illuminate to indicate direction. To illustrate a top of the frame may illuminate to indicate that a thermal source 316 is upward from the center of the camera's view 308. The left, right, bottom, or corners may illuminate to indicate that the thermal source 316 is to the left, right, bottom, or diagonal from the center of the camera's view 308.

As will be described below, the display 108 need not show the direction indicator 220 or the thermal indicator 224 in some operating modes of the infrared locator. In addition, in some operating modes only the direction indicator 220 or only the thermal indicator 224 may be displayed. In other operating modes both indicators 220,224 may be displayed, such as shown in FIGS. 3A-3C.

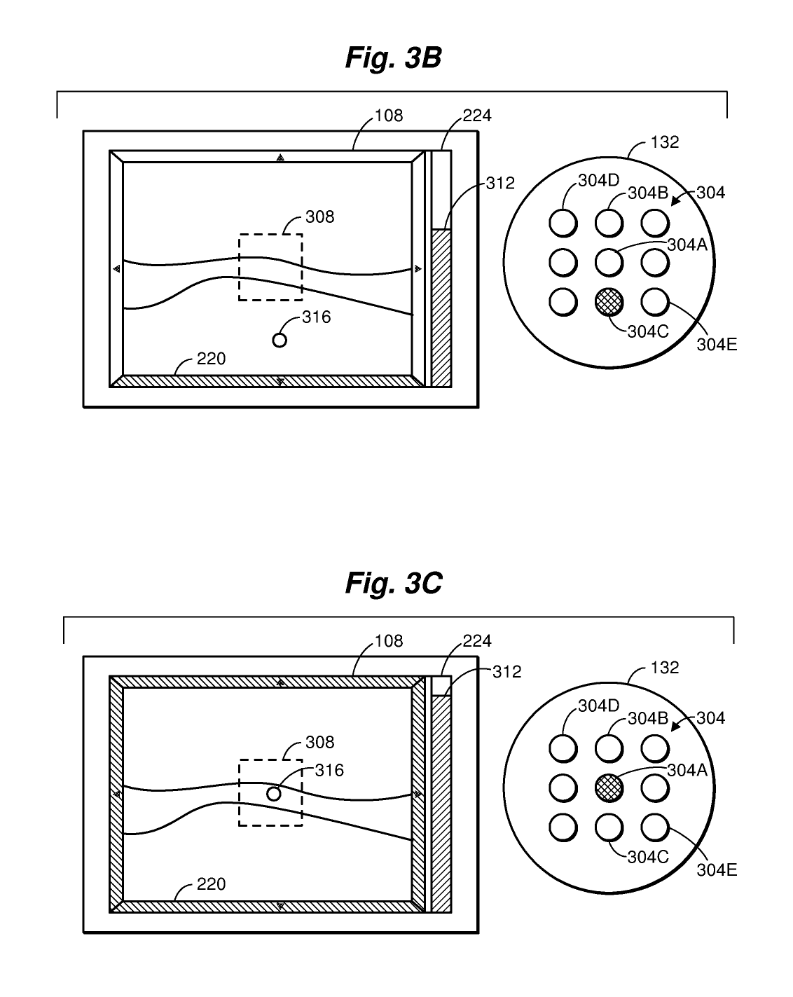

FIG. 4 is a flow diagram illustrating operation of an exemplary infrared locator. It is noted that a processor of the infrared locator may be configured to perform these steps. As can be seen, the infrared locator may display an image at a step 404 when the infrared locator on. This image will typically be one captured from a camera of the infrared locator and may be displayed on the display of the infrared locator, such as described above.

At a step 408, which may occur simultaneously or before step 404, thermal information may be captured or collected by a thermal detector of the infrared locator. At a step 412, this thermal information may be analyzed to determine the intensity of thermal radiation (and thus temperature) at various areas of the scene being captured by the camera. As stated, this may occur by measuring the intensity of thermal radiation at each of a plurality of thermal sensors. One or more thermal sensors measuring or detecting higher or the highest intensity of thermal radiation may indicate the location of a thermal source.

A direction indicator of the thermal locator may be activated accordingly, at a step 416. In general, the direction indicator will be activated to show which of the thermal sensors has detected the thermal source. As disclosed above for example, an arrow or portion of the direction indicator may be illuminated to indicate which of the thermal sensors is receiving higher or the highest thermal radiation intensity. It is noted that the infrared locator's thermal indicator may also be updated based on the thermal information detected by the sensors, such as at a step 420. In this manner, the thermal indicator shows the user temperature information for the scene the user is viewing.

At a decision step 424, it may be determined if the thermal source has been centered in the camera's view. If not, the infrared locator may continue to operate as described above, illuminating portions of the direction indicator to assist the user find the thermal source. If the thermal source has been centered, then a distinct indication of the same may be provided at a step 428. For example, as discussed above, the entire direction indicator may be illuminated. In addition, the direction indicator may be made to blink in some embodiments. Alternatively or in addition, a separate indicator may be illuminated. It is contemplated that one or more audible alerts or notifications can be provided as well.

Once the thermal source is centered, one or more images of the scene may be recorded at a step 432, such as by saving the image captured by the infrared locator's camera to a memory device. It is noted that images may be recorded automatically upon centering the thermal source. Alternatively, images may only be manually recorded such as by the user engaging a shutter or record button.

It is also noted that images may be recorded at various times. For example, the infrared locator may record video as the user is attempting to find and/or centering the thermal source in the camera's view. As discussed above, thermal information, such as temperature readings from individual thermal sensors may be recorded along with the captured images.

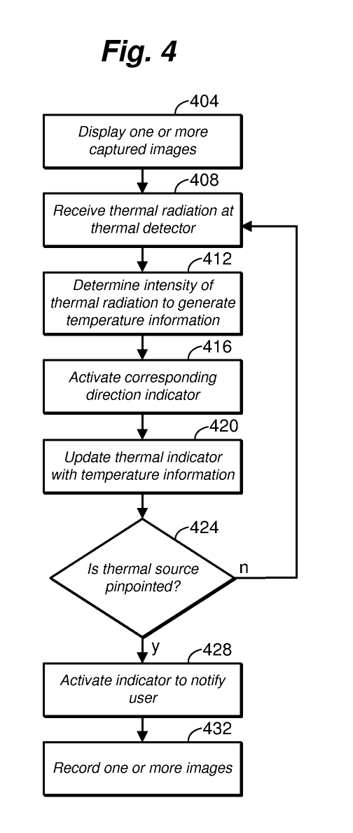

FIG. 5 is a flow diagram illustrating some exemplary operating modes of the infrared locator. These modes may be activated by the user, such as by activating the mode button or another input as disclosed above. The operating modes are beneficial in that the allow the user to quickly access a particular display configuration that may be better suited for the user's current task, as will now be described.

As can be seen from FIG. 5, a user may toggle through various operating modes of the infrared locator in a rotating or circular fashion. Each activation of a mode button or the like may switch the infrared locator to its next operating mode. It is contemplated that individual buttons may be provided as well, such as to cause the infrared locator to immediately enter a particular operating mode associated with each button.

In the embodiment shown, the infrared locator has three exemplary operating modes. Operating mode 504 is a mode where the display of the infrared locator shows an image captured by its camera and framed by the direction indicator. Operating mode 508 is a mode where the display shows the image captured by the camera with a thermal indicator at the side. Operating mode 512 is a mode where only thermal information is displayed. For example, in operating mode 512, only information captured by the thermal detector of the infrared locator may be displayed on the infrared locator's display.

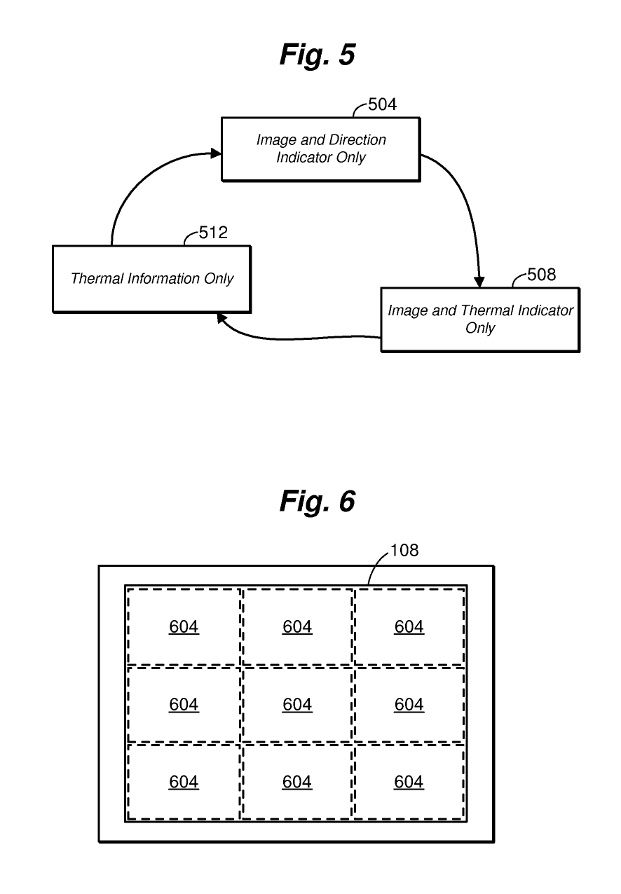

FIG. 6 illustrates the infrared locator 104 in operating mode 512. As can be seen, the display 108 may show thermal information corresponding to thermal information generated at each of the infrared locator's thermal sensors. In an embodiment where the thermal sensors are arranged in a grid for example, the display 108 may present a corresponding grid where each individual block 604 or section is associated with a corresponding thermal sensor. Each block 604 can then show thermal information for a corresponding thermal sensor. Since the thermal sensors may be arranged to detect thermal radiation at various areas of a scene, each block 604 accordingly displays the thermal information for these particular areas of the scene. The user can then identify areas of higher and lower thermal radiation intensity within the scene.

Each block 604 may present thermal information by color or with numbers, characters, or other symbols. For example, the temperature level at a block 604 may be represented by a color, a number, a word, or a symbol/icon. In one or more embodiments, a particular color, number, word, or symbol may be associated with a temperature or a temperature range. A user viewing a block 604 would then know the temperature detected at the block. No image from the camera may be displayed in this operating mode 512, however the user may toggle between this operating mode and others to view a camera image of the scene such as to associate the blocks 604 with the scene.

It is contemplated that the display 108 in operating mode 512 need not show discrete blocks 604. For instance, temperature information may be interpolated from adjacent blocks 604 and used to provide calculated or estimated temperature information for the areas between thermal sensors. To illustrate, the display 108 may show the calculated or estimated temperatures along with actual temperature information from the thermal sensors.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An infrared locator comprising:
a camera for capturing one or more images;
a thermal detector comprising a plurality of thermal sensors for capturing thermal information, the thermal detector aligned with the camera;
a display having an image area configured to display the one or more images; and
a direction indicator configured to indicate a location of a thermal source based on the thermal information.

2. The infrared locator of claim 1 further comprising a thermal indicator configured to display the thermal information outside the image area.

3. The infrared locator of claim 1, wherein the direction indicator presents one or more arrows to indicate the location of the thermal source.

4. The infrared locator of claim 1, wherein the direction indicator comprises a frame surrounding the image area, the direction indicator having a plurality of sections that alter their appearance to indicate the location of the thermal source.

5. The infrared locator of claim 1, wherein the plurality of thermal sensors is arranged in a grid pattern, and the thermal detector is aligned with the camera such that a center thermal sensor is focused on the same area as the camera.

6. The infrared locator of claim 1, wherein the direction indicator has a plurality of segments, each of the segments associated with one of the plurality of thermal sensors.

7. The infrared locator of claim 5, wherein one of the plurality of segments is activated when its associated thermal sensor detects the highest thermal radiation intensity of all the plurality of thermal sensors.

8. An infrared locator comprising:
a camera configured to capture one or more images of a scene having a plurality of areas;
a plurality of thermal sensors arranged in a predefined arrangement such that each of the plurality of thermal sensors receives thermal radiation from one of the plurality of areas of the scene, the plurality of thermal sensors configured to generate temperature information from the thermal radiation;
a display having an image area configured to display one or more images captured by the camera;
a direction indicator surrounding the image area, the direction indicator having a plurality of segments configured to change their appearance to indicate the location of a thermal source, each of the plurality of segments associated with one of the plurality of areas of the scene;
a processor configured to change the appearance of one of the plurality of segments based on a comparison between temperature information from an area associated with the one of the plurality of segments and temperature information from the other areas of the scene.

9. The infrared locator of claim 8, wherein the processor changes the appearance of the one of the plurality of segments when the thermal information from the area associated with the one of the plurality of segments is higher than the temperature information from the other areas of the scene.

10. The infrared locator of claim 8, wherein the infrared locator has a plurality of operating modes and the display is configured to display only temperature information in at least one of the operating modes.

11. The infrared locator of claim 8, wherein the infrared locator has a plurality of operating modes and the display is configured to replace the direction indicator with a graph showing temperature information from one or more of the plurality of thermal sensors in at least one of the operating modes, the graph being located outside the image area.

12. The infrared locator of claim 8, wherein the direction indicator comprises a plurality of lights arranged around the display, wherein the plurality of segments are configured to change their appearance by illuminating one or more of the plurality of lights.

13. The infrared locator of claim 8, wherein the processor is configured to change the appearance of all of the plurality of segments when highest temperature information is being detected by a centrally located one of the plurality of thermal sensors.

14. The infrared locator of claim 8 further comprising one or more memory devices configured to record one or more of the one or more images of the scene.

15. A method of locating a source of thermal radiation comprising:
providing an infrared locator comprising a plurality of thermal sensors and a camera;
displaying an image of a scene captured by the camera on a display of the infrared locator;
receiving thermal radiation from various areas of the scene at each of the plurality of thermal sensors;
generating temperature information from the thermal radiation, the temperature information indicating the temperature of the various areas of the scene;
providing a first operating mode wherein a portion of a direction indicator indicates the location of the source of thermal radiation by changing its appearance, whereby the portion of the direction indicator is selected based on the temperature information; and
providing a second operating mode wherein a graph showing temperature information is displayed next to the image of the scene on the display of the infrared locator.

16. The method of claim 15 further comprising providing a third operating mode wherein only the temperature information is displayed on the display of the infrared locator.

17. The method of claim 15, wherein the entire direction indicator changes its appearance when a centrally located one of the plurality of thermal sensors detects a higher temperature than the other of the plurality of thermal sensors.

18. The method of claim 15, wherein an additional indicator is activated when a centrally located one of the plurality of thermal sensors detects a higher temperature than the other of the plurality of thermal sensors.

19. The method of claim 15 further comprising recording the image of the scene on a memory device of the infrared locator.

20. The method of claim 15 further comprising automatically recording the image of the scene on a memory device of the infrared locator when a centrally located one of the plurality of thermal sensors detects a higher temperature than the other of the plurality of thermal sensors.
